(19) United States
(12) Patent Application Publication
(10) Pub. No.: US 2014/0177799 A1
(43) Pub. Date: Jun. 26, 2014

(54) X-RAY IMAGING APPARATUS

(71) Applicants: Toshiba Medical Systems Corporation, Otawara-shi (JP); Kabushiki Kaisha Toshiba, Minato-ku (JP)

(72) Inventor: Koji NODA, Nasushiobara-shi (JP)

(73) Assignees: Toshiba Medical Systems Corporation, Otawara-shi (JP); Kabushiki Kaisha Toshiba, Minato-ku (JP)

(21) Appl. No.: 14/193,944

(22) Filed: Feb. 28, 2014

Related U.S. Application Data
(63) Continuation of application No. PCT/JP2013/064111, filed on May 21, 2013.

(30) Foreign Application Priority Data
May 21, 2012 (JP) 2012-115459
May 21, 2013 (JP) 2013-106919

(51) Int. Cl. H05G 1/02; G01N 23/04

(52) U.S. Cl. CPC H05G 1/02; G01N 23/04
USPC 378/62

(57) ABSTRACT

An X-ray imaging apparatus includes: a C-arm formed in a C-shaped arc form, and being capable of sliding in an arc direction; an X-ray generator held on one end side of the C-arm; an X-ray detector held on the other end side of the C-arm while being opposed to the X-ray generator; and a first rotation axis which is fixed at a fixation portion to a ceiling portion of a room where the C-arm is installed, and which enables the C-arm to be rotated about an axial center of the first rotation axis, the axial center being a normal line extending in a vertical direction from the center of the fixation portion.

### CROSS-REFERENCE TO THE RELATED APPLICATION

This application is based on and claims the benefit of priority from International Application No. PCT/JP2013/064111, filed on May 21, 2013, Japanese Patent Application No. 2012-115459, filed on May 21, 2012 and Japanese Patent Application No. 2013-106919, filed on May 21, 2013; the entire contents of which are incorporated herein by reference.

### FIELD

Embodiments described herein relate generally to an X-ray imaging apparatus.

### BACKGROUND

In recent years, a system using a common bed for both catheterization and surgery has been widely used. This system uses an X-ray imaging apparatus including a C-arm for performing catheterization on the bad. The C-arm is a member formed in a C-shaped arc form, and having an X-ray generator held on one end and an X-ray detector held on the other end. When a surgery is performed on the bed, this C-arm of the X-ray imaging apparatus needs to be retreated from the bed in order not to disturb the surgery.

As a driving mechanism of the C-arm, there is known a floor stand type of C-arm driving mechanism with a five-axis structure as described in Japanese Patent Application Publication No. 2008-86836. In addition, there is known an overhead traveling type of C-arm driving mechanism as described in Japanese Patent Application Publication No. 2011-142964.

The C-arm driving mechanism with the five-axis structure includes five rotation axes. Specifically, there are a first rotation axis having a vertical axial center, a second rotation axis having an axial center in parallel with that of the first rotation axis, and a third rotation axis having a horizontal axial center intersecting the second rotation axis. In addition, there are a fourth rotation axis provided to extend in a direction intersecting the third rotational axis, and serving as the center of rotation about which the C-arm rotates in its arc direction, and a fifth rotation axis about which the X-ray generator and the X-ray detector rotate when rotating about an imaging axis connecting a focus of the X-ray generator and the center of the X-ray detector. Such a C-arm driving mechanism is configured such that, when the second rotation axis is at a standstill in a particular set position within its own rotation angle range, the other rotation axes intersect each other at a fixed point called an isocenter.

On the other hand, the overhead traveling type of C-arm driving mechanism is provided to be capable of retreating along ceiling rails installed on a ceiling surface.

In the C-arm driving mechanism of the five-axis structure, however, a maximum retreat length indicating a longest distance by which the C-arm can be retreated in a retreat from the bed is determined by a length between the isocenter and the second rotation axis. For this reason, there is a case where the C-arm cannot be retreated from the bed by a sufficient distance and disturbs a surgery.

In the case of the overhead traveling type of C-arm driving mechanism, the ceiling rails are installed on the ceiling. For this reason, in a case where surgical equipment necessary for surgeries, such as anesthetic equipment, a shadowless operating light and an electrocardiogram monitor, for example, is planned to be installed on a ceiling side, the ceiling rails are an obstacle to the installation of the surgical equipment.

### BRIEF DESCRIPTION OF THE DRAWINGS

FIG. 1 is a perspective view of an X-ray imaging apparatus in a first embodiment and a bed.

FIG. 2 is a plan view illustrating a positional relationship between a C-arm and the bed in catheterization.

FIG. 3 is a plan view illustrating a first retreat step of retreating the C-arm from the bed.

FIG. 4 is a plan view illustrating a second retreat step of retreating the C-arm from the bed.

FIG. 5 is a plan view illustrating a third retreat step of retreating the C-arm from the bed.

FIG. 6 is a plan view illustrating a fourth retreat step of retreating the C-arm from the bed.

FIG. 7 is an explanatory diagram of a case where an X-ray detector moves on a straight line in a longitudinal direction of a tabletop in catheterization in a second embodiment.

FIG. 8 is an explanatory diagram of a case where the X-ray detector moves on a straight line in a crosswise direction that is orthogonal to the longitudinal direction of the tabletop in catheterization.

FIG. 9 is a perspective view illustrating a first retreat step of retreating a C-arm from a bed in a third embodiment.

FIG. 10 is a perspective view illustrating a second retreat step of retreating the C-arm from the bed in the third embodiment.

FIG. 11 is a perspective view illustrating another retreat example where the C-arm is retreated from the bed in the third embodiment.

### DETAILED DESCRIPTION

According to an embodiment, an X-ray imaging apparatus includes: a C-arm formed in a C-shaped arc form, and being capable of sliding in an arc direction; an X-ray generator held on one end side of the C-arm; an X-ray detector held on the other end side of the C-arm while being opposed to the X-ray generator; and a first rotation axis which is fixed at a fixation portion to a ceiling portion of a room where the C-arm is installed, and which enables the C-arm to be rotated about an axial center of the first rotation axis, the axial center being a normal line extending in a vertical direction from the center of the fixation portion.

In addition, according to another embodiment, an X-ray imaging apparatus includes: a first rotation axis fixed at a fixation portion to a ceiling portion and having as an axial center a normal line extending in a vertical direction from the center of the fixation portion; a holding body joined to the first rotation axis in a manner rotatable about the axial center of the first rotation axis; a long ceiling support arm joined to the holding body in a manner rotatable about the axial center of the first rotation axis, and extending in a direction horizontal to the ceiling portion; a sliding body joined to the ceiling support arm and being capable of sliding in a longitudinal direction of the ceiling support arm; a second rotation axis having a joint portion on an upper end side thereof joined to the sliding body, and having as an axial center a normal line extending in the vertical direction from the center of the joint portion of the second rotation axis; a long horizontal support arm including one end side joined to a lower end side of the second rotation axis, extending in a horizontal direction and being rotatable about the axial center of the second rotation axis; a third rotation axis having a joint portion of an upper end thereof joined to the other end side of the horizontal support arm in a longitudinal direction, and having as an axial center a normal line extending in the vertical direction from the center of the joint portion of the third rotation axis; a rotation axis housing portion joined to a lower end side of the third rotation axis; a horizontal rotation axis housed in the rotation axis housing portion and having a horizontal axial center being orthogonal to the axial centers; a holder portion held to be rotatable about the axial center of the horizontal rotation axis; a C-arm formed in a C-shaped arc form and held by the holder portion in a manner capable of sliding in an arc direction; an X-ray generator held on one end side of the C-arm; and an X-ray detector held on the other end side of the C-arm while being opposed to the X-ray generator.

### First Embodiment

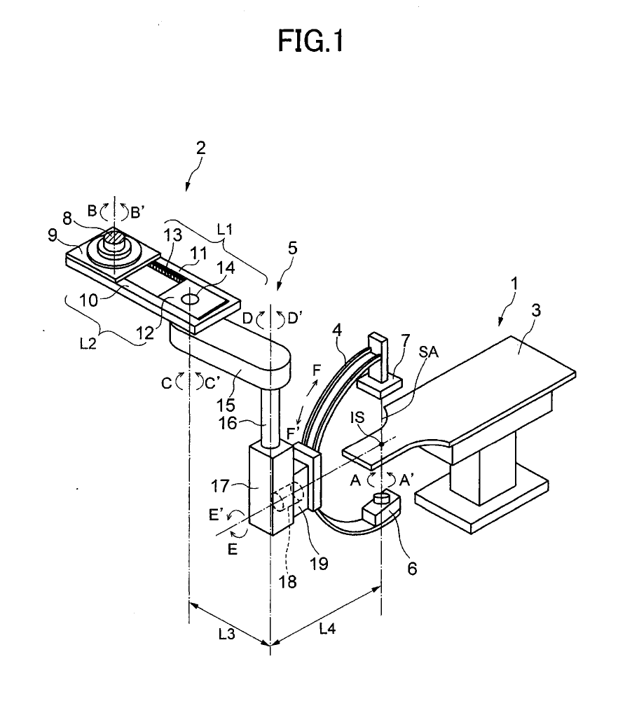

A first embodiment of the present invention will be described on the basis of FIG. 1 to FIG. 6. FIG. 1 is a perspective view illustrating a bed 1 used in a case of performing catheterization or surgery, and an X-ray imaging apparatus 2 used in a case of performing catheterization.

The bed 1 includes a long tabletop 3 which is capable of sliding in its longitudinal direction. A subject who undergoes catheterization or surgery is laid on the tabletop 3 with his/her body axis aligned in the longitudinal direction of the tabletop 3

The X-ray imaging apparatus 2 includes a C-arm 4 and a C-arm driving mechanism 5 configured to drive the C-arm 4.

The C-arm 4 is a member formed in a C-shaped arc form. An X-ray generator 6 is held on one end side of the C-arm 4, and an X-ray detector 7 is held on the other end side of the C-arm 4. The X-ray generator 6 and the X-ray detector 7 are arranged to be opposed to each other so that the X-ray detector 7 can detect an X-ray emitted from the X-ray generator 6. The X-ray generator 6 and the X-ray detector 7 are provided to be rotatable in arrow A-A′ directions about an imaging axis SA connecting a focus of the X-ray generator 6 and the center of the X-ray detector 7.

The C-arm driving mechanism 5 includes a first rotation axis 8. This first rotation axis 8 is fixed to a ceiling portion of a room where the bed 1 and the X-ray imaging apparatus 2 are installed, and holds the entire X-ray imaging apparatus 2 including the C-arm 4 and the C-arm driving mechanism 5. The first rotation axis 8 has as an axial center a normal line extending in a vertical direction, and enables the X-ray imaging apparatus 2 to be rotated in arrow B-B′ directions about the axial center. Although the description herein is provided on the assumption that the first rotation axis 8 is fixed to the ceiling portion, the first rotation axis 8 itself may rotate in the arrow B-B′ directions to rotate the X-ray imaging apparatus 2, for example.

The first rotation axis 8 holds a holding body 9. The holding body 9 is able to move by means of a not-illustrated driving mechanism along the periphery of the first rotation axis 8 by rotating about the axial center of the first rotation axis 8.

The holding body 9 holds a long ceiling support arm 10 extending in a horizontal direction. The ceiling support arm 10 is capable of sliding in its longitudinal direction relative to the holding body 9. Here, in FIG. 1, a maximum slide length of the ceiling support arm 10 is indicated by “L1.” The “maximum slide length” is a longest distance by which the ceiling support arm 10 can be slid.

A slide operation of the ceiling support arm 10 relative to the holding body 9 is carried out by use of the same kind of mechanism as that of a sliding body 12, which will be described later. The ceiling support arm 10 is configured to rotate together with the holding body 9 about the axial center of the first rotation axis 8.

Incidentally, the ceiling support arm 10 needs to have strength and stiffness high enough to bear an overhang load of the C-arm 4. For this reason, the ceiling support arm 10 preferably has a frame structure made of a carbon fiber reinforced resin, for example.

The ceiling support arm 10 includes a pair of long slide rails 11 which form long sides of the ceiling support arm 10. Each slide rail 11 is formed such that a lateral side and an upper side thereof can serve as mounting sides. Specifically, the slide rails 11 include two pairs of slide rails configured to engage with and hold the holding body 9 and the sliding body 12, respectively.

The holding body 9 and the sliding body 12 are each provided with a pinion gear and a motor, which are not illustrated. The pinion gear meshes with a rack gear 13 formed at an edge portion of one of the slide rails 11. When the motor drives and rotates the pinion gear, the sliding body 12 can be slid in the longitudinal direction of the slide rails 11. In FIG. 1, a maximum slide length of the sliding body 12 is indicated by “L2.”

In addition, an upper end side of a second rotation axis 14 having a vertical axial center is joined to and held by the sliding body 12. The second rotation axis 14 is rotatable about the axial center in arrow C-C′ directions by a motor not illustrated.

One end side of a long horizontal support arm 15 extending in a horizontal direction is held on a lower end side of the second rotation axis 14. The horizontal support arm 15 is configured to be rotatable about the axial center of the second rotation axis 14 along with the rotation of the second rotation axis 14 about the axial center.

An upper end side of a third rotation axis 16 having as an axial center a normal line extending in the vertical direction is joined to and held by the other end side of the horizontal support arm 15 in the longitudinal direction. This third rotation axis 16 is configured to be rotatable about the axial center in arrow D-D′ directions by a motor not illustrated. Here, a length between the axial center of the third rotation axis 16 and the axial center of the second rotation axis 14 is indicated by “L3.”

A rotation axis housing portion 17 is held on a lower end side of the third rotation axis 16. A horizontal rotation axis 18 having a horizontal axial center orthogonal to the axial center of the third rotation axis 16 is housed in the rotation axis housing portion 17. The horizontal rotation axis 18 is configured to be rotatable about the axial center in arrow E-E′ directions by a motor not illustrated.

A holder portion 19 is held on one end side of the horizontal rotation axis 18. The holder portion 19 rotates about the axial center of the horizontal rotation axis 18 along with the rotation of the horizontal rotation axis 18 about the axial center.

The holder portion 19 holds the C-arm 4. The C-arm 4 is formed in the C-shaped arc form as described above. The C-arm 4 is driven by a motor not illustrated and thereby slides in arrow F-F′ directions. The arrow F-F′ directions of the slide coincide with the arc direction of the C-arm 4.

Here, an isocenter IS is defined as a point where an extending line of the axial center of the horizontal rotation axis 18 intersects the imaging axis SA on which the X-ray generator 6 and the X-ray detector 7 are opposed to each other. In FIG. 1, a length between the isocenter IS and the axial center of the third rotation axis 16 is indicated by “L4.”

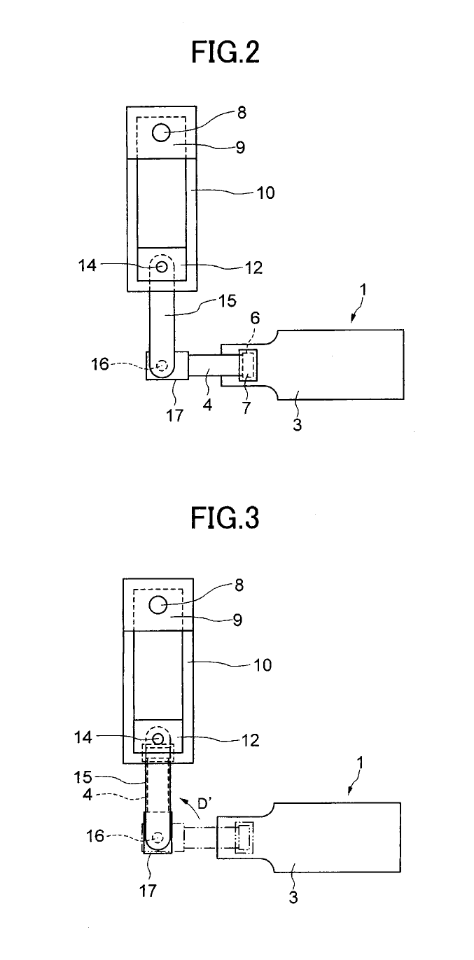

FIG. 2 is a plan view illustrating a positional relationship between the C-arm 4 and the bed 1 in catheterization. In the catheterization, the ceiling support arm 10 is slid to a position nearest possible to the bed 1. In addition, the sliding body 12 is also slid to a position nearest possible to the bed 1. Moreover, the horizontal support arm 15 is rotated to such a position as to bring the C-arm 4 close to the tabletop 3. The C-arm 4 is located at such a position that the tabletop 3 is placed between the X-ray generator 6 and the X-ray detector 7. Here, the X-ray generator 6 is indicated by a broken line in FIG. 2, because the X-ray generator 6 is hidden under the X-ray detector 7 and thus cannot be seen.

In catheterization of a subject laid on the tabletop 3 of the bed 1, the C-arm 4 is located at such position that the tabletop 3 is placed between the X-ray generator 6 and the X-ray detector 7 as illustrated in FIG. 1 or 2. In the catheterization, the first rotation axis 8, the second rotation axis 14, the third rotation axis 16 and the horizontal rotation axis 18 are rotated about their respective axial centers. The X-ray generator 6 and the X-ray detector 7 are rotated about the imaging axis SA and further the C-arm 4 is slid in the arrow F-F′ directions. The C-arm 4, the X-ray generator 6 and the X-ray detector 7 are rotated in proper directions as needed in the above way, so that imaging in various directions can be carried out.

Next, description will be provided for a case where a surgery is performed on a subject laid on the tabletop 3 of the bed 1. In this case, it is necessary to prevent the C-arm 4 used in the catheterization from disturbing the surgery. To this end, the C-arm 4 is retreated from the bed 1.

Hereinafter, first to fourth retreat steps of retreating the C-arm 4 from the bed 1 will be described step by step by using FIG. 3 to FIG. 6. The description herein is provided on the assumption that the C-arm 4 and the bed 1 at the start of the retreat steps are located in a positional relationship illustrated in FIG. 2. FIG. 3 to FIG. 6 are plan views illustrating the respective retreat steps of retreating the C-arm 4 from the bed 1

To begin with, the first retreat step of retreating the C-arm 4 from the bed 1 is described with reference to FIG. 3. In this first retreat step, the third rotation axis 16 is rotated about its own axial center by an angle of 90° in the arrow D′ direction. Along with the rotation of the third rotation axis 16, the C-arm 4 is rotated about the axial center of the third rotation axis 16 in the arrow D′ direction. As a result, the C-arm 4 is moved to under the horizontal support arm 15. In FIG. 3, the C-arm 4 is indicated by a broken line, because the C-arm 4 is located under the horizontal support arm 15. With this movement, the C-arm 4 is retreated from the position at which the tabletop 3 of the bed 1 is placed between both ends of the C-arm 4 as illustrated in FIG. 2.

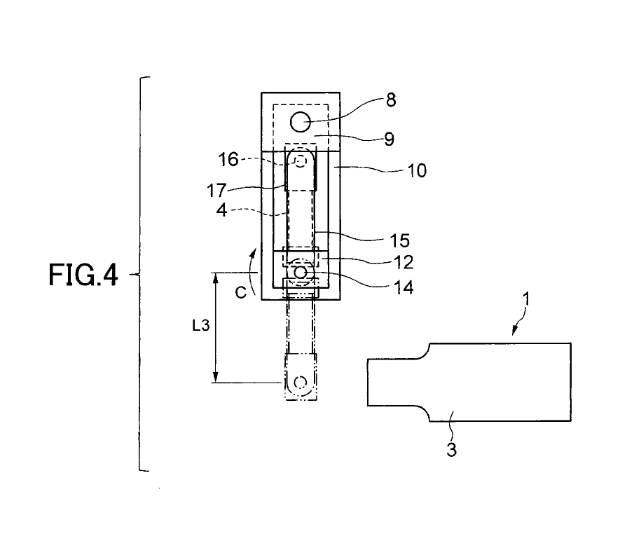

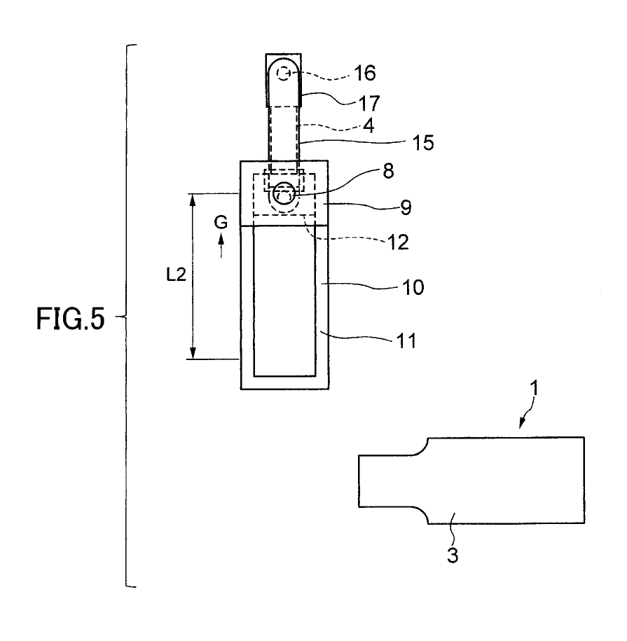

Next, the second retreat step of retreating the C-arm 4 from the bed 1 is described with reference to FIG. 4. In this second retreat step, the horizontal support arm 15 is rotated about the axial center of the second rotation axis 14 by an angle of 180° in the arrow C direction. With this rotation, the C-arm is further retreated from the bed 1 by rotating together with the horizontal support arm 15 and moving to under the ceiling support arm 10. In this case, a retreat length of the C-arm 4 from the bed 1 is equal to the length “L3” between the axial center of the second rotation axis 14 and the axial center of the third rotation axis 16.

Next, the third retreat step of retreating the C-arm 4 from the bed 1 is described with reference to FIG. 5. In this third retreat step, the sliding body 12 is slid in an arrow G direction along the slide rails 11 formed in the ceiling support arm 10, and is moved to under the holding body 9.

The sliding body 12 slides by meshing the pinion gear with the rack gear 13 (see FIG. 1) formed at the edge portion of the slide rail 11 while the pinion gear is driven and rotated by the motor provided to the sliding body 12. With the movement of the sliding body 12, both the horizontal support arm 15 and the C-arm 4 are moved in the arrow G direction.

Consequently, the C-arm 4 is further retreated from the bed 1 by sliding the sliding body 12. The maximum retreat length of the C-arm 4 from the bed 1 in the third retreat step is equal to the maximum slide length “L2” indicating the longest distance by which the sliding body 12 can be slid in the slide operation.

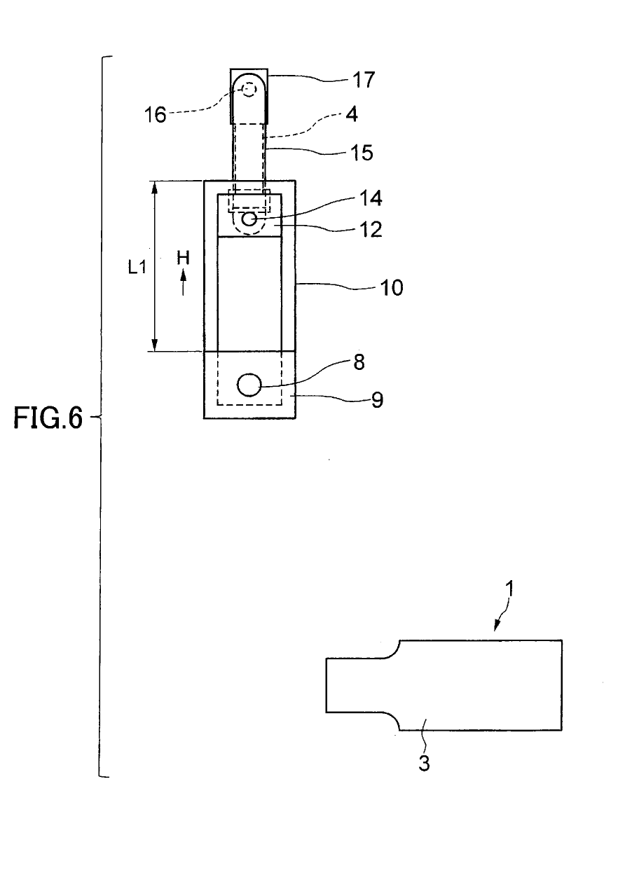

Lastly, the fourth retreat step of retreating the C-arm 4 from the bed 1 is described with reference to FIG. 6. In this fourth retreat step, the ceiling support arm 10 is slid in an arrow H direction, which is a direction orthogonal to the axial center of the first rotation axis 8, i.e., a direction horizontal to the ceiling portion. This slide operation of the ceiling support arm 10 is achieved by a slide operation of the holding member 9 and the ceiling support arm 10, and is driven by a mechanism similar to that of the aforementioned sliding body 12. With the movement of the ceiling support arm 10, the sliding body 12, the horizontal support arm 15 and the C-arm 4 are moved all together in the arrow H direction. Thus, the C-arm 4 is further retreated from the bed 1 by sliding the ceiling support arm 10. The maximum retreat length of the C-arm 4 from the bed 1 in the fourth retreat step is equal to the maximum slide length “L1” of the ceiling support arm 10 relative to the holding body 9.

As described above, in the case of retreating the C-arm 4 from the bed 1, the C-arm 4 is firstly rotated in the arrow D′ direction as illustrated in FIG. 3, and then is rotated together with the horizontal support arm 15 in the arrow C direction as illustrated in FIG. 4. Next, the C-arm 4 is slid together with the sliding body 12 in the arrow G direction as illustrated in FIG. 5, and is further slid together with the ceiling support arm 10 in the arrow H direction as illustrated in FIG. 6.

The retreat length of the C-arm 4 in each of the steps is as follows. First, in the second retreat step in which the C-arm 4 is rotated together with the horizontal support arm 15 in the arrow C direction, the retreat length of the C-arm 4 from the bed 1 is “L3” as illustrated in FIG. 4. Second, in the third retreat step in which the C-arm 4 is slid together with the sliding body 12 in the arrow G direction, the retreat length of the C-arm 4 from the bed 1 is “L2” at maximum as illustrated in FIG. 5. Third, in the fourth retreat step in which the C-arm 4 is slid together with the ceiling support arm 10 in the arrow H direction, the retreat length of the C-arm 4 from the bed 1 is “L1” at maximum as illustrated in FIG. 6.

Accordingly, in the case of performing a surgery on a subject laid on the tabletop 3 of the bed 1, the C-arm 4 located at the position for the catheterization can be retreated from the bed 1 by a distance of the length “L3+L2+L1,” at maximum.

In this way, in the case of performing a surgery on a subject, the C-arm 4 can be retreated from the bed 1 by a large distance, and thereby the C-arm 4 can be prevented from disturbing the surgery.

In addition, the X-ray imaging apparatus according to the present embodiment is fixed to the ceiling portion only by the first rotation axis. Thus, there are no ceiling rails used to hold and move the X-ray imaging apparatus, and a sufficient installation space can be reserved on the ceiling side as well. This enables surgical equipment necessary for surgeries (for example, anesthetic equipment, a shadowless operating light, an electrocardiogram monitor and the like) to be installed on the ceiling side without facing an obstacle of the ceiling rails.

Incidentally, although the present embodiment has been described by taking as an example the case where the slide operation of the ceiling support arm 10 in the arrow G direction is carried out by an electric mechanism using the rack gear, the pinion gear and the motor, this slide operation may be performed manually.

### Second Embodiment

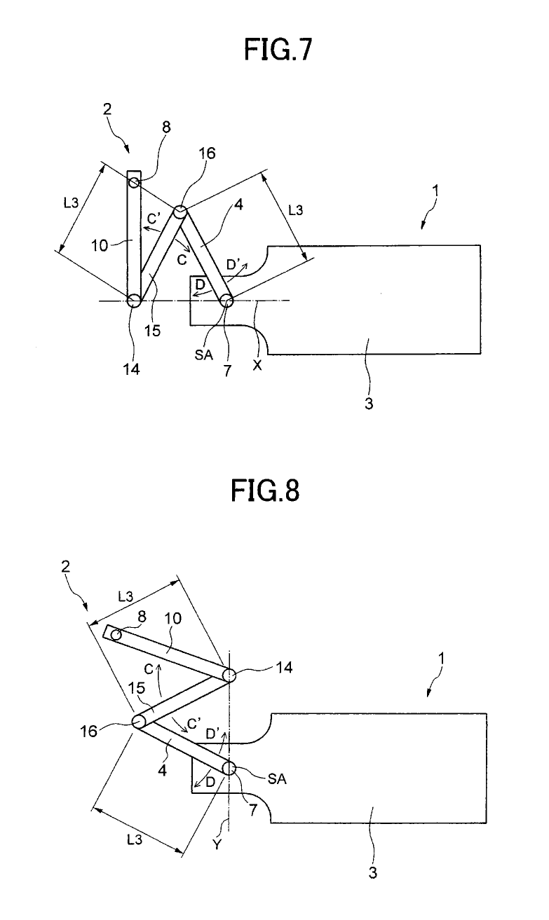

Next, a second embodiment of the present invention will be described on the basis of FIG. 7 and FIG. 8. In the second embodiment, the same constituents as the constituents described above in the first embodiment will be designated by the same reference numerals and duplicate explanation of the same constituents will be omitted herein.

The second embodiment has the same basic structure as that in the first embodiment, but is different from the first embodiment in the following point. Specifically, the length “L4,” which is the length between the imaging axis SA and the axial center of the third rotation axis 16 as described in the first embodiment, is set to be equal to the length “L3” between the axial center of the third rotation axis 16 and the axial center of the second rotation axis 14.

FIG. 7 is a schematic plan diagram illustrating a positional relationship between the C-arm 4, the horizontal support arm 15 and the tabletop 3 in a case of performing catheterization. FIG. 7 illustrates the case where the imaging axis SA and the second rotation axis 14 are located on a straight line “X” extending in the longitudinal direction of the tabletop 3.

In this configuration, from the state illustrated in FIG. 7, the horizontal support arm 15 is rotated about the axial center of the second rotation axis 14 in the arrow C direction, and the C-arm 4 is rotated about the axial center of the third rotation axis 16 in the arrow D′ direction at the same time. Instead, the horizontal support arm 15 is rotated about the axial center of the second rotation axis 14 in the arrow C′ direction, and the C-arm 4 is rotated about the axial center of the third rotation axis 16 in the arrow D direction at the same time.

In these cases, the imaging axis SA moves on the straight line “X” if the rotation angle of the horizontal support arm 15 and the rotation angle of the C-arm 4 are kept constantly equal to each other. Thus, a subject can be imaged along the longitudinal direction of the tabletop 3 and moreover this imaging can be achieved only by taking simple control of keeping the rotation angle of the horizontal support arm 15 and the rotation angle of the C-arm 4 constantly equal to each other.

FIG. 8 is a schematic plan diagram illustrating a positional relationship between the C-arm 4, the horizontal support arm 15 and the tabletop 3 in a case of performing catheterization. FIG. 8 illustrates the case where the imaging axis SA and the second rotation axis 14 are located on a straight line “Y” orthogonal to the longitudinal direction of the tabletop 3.

Then, from the state illustrated in FIG. 8, the horizontal support arm 15 is rotated about the axial center of the second rotation axis 14 in the arrow C direction, and the C-arm 4 is rotated about the axial center of the third rotation axis 16 in the arrow D′ direction at the same time. Instead, the horizontal support arm 15 is rotated about the axial center of the second rotation axis 14 in the arrow C′ direction, and the C-arm 4 is rotated about the axial center of the third rotation axis 16 in the arrow D direction at the same time.

In these cases, the imaging axis SA moves on the straight line “Y” if the rotation angle of the horizontal support arm 15 and the rotation angle of the C-arm 4 are kept constantly equal to each other. Thus, a subject can be imaged along a crosswise direction orthogonal to the longitudinal direction of the tabletop 3. Moreover, this imaging can be achieved only by taking simple control of keeping the rotation angle of the horizontal support arm 15 and the rotation angle of the C-arm 4 constantly equal to each other.

In addition, in the second embodiment, in the case of performing a surgery on a subject laid on the tabletop 3 of the bed 1, the X-ray imaging apparatus 2 can be also retreated by a large distance as is the case with the explanation in the first embodiment.

Specifically, the C-arm 4 is rotated about the axial center of the third rotation axis 16, and thereby is moved to under the horizontal support arm 15. Then, the horizontal support arm 15 is rotated about the axial center of the second rotation axis 14, and thereby the C-arm 4 is positioned together with the horizontal support arm 15 under the ceiling support arm 10. Further, the sliding body 12 (see FIG. 1) holding the second rotation axis 14 is slid in a direction away from the bed 1 along the slide rails 11 (see FIG. 1) formed in the ceiling support arm 10. Lastly, the ceiling support arm 10 is slid in the direction away from the bed 1, so that the C-arm 4 can be retreated to a position where the C-arm 4 does not disturb the surgery.

Further, the second embodiment uses no ceiling rails as in the first embodiment, either. Thus, a sufficient installation space can be also reserved on a ceiling side, and surgical equipment necessary for surgeries can be installed on the ceiling side without facing an obstacle of the ceiling rails.

### Third Embodiment

Next, a third embodiment of the present invention will be described. In the third embodiment, the same constituents as the constituents described above in the first embodiment or the second embodiment will be designated by the same reference numerals and duplicate explanation of the same constituents will be omitted herein.

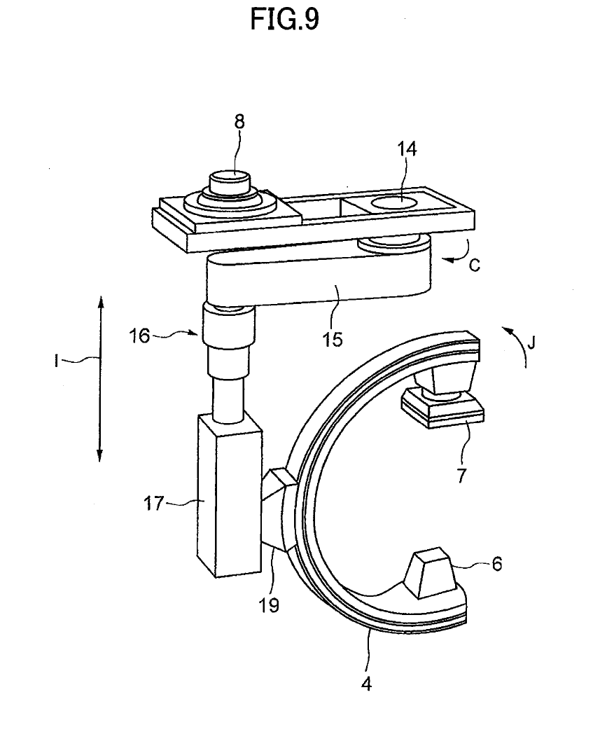

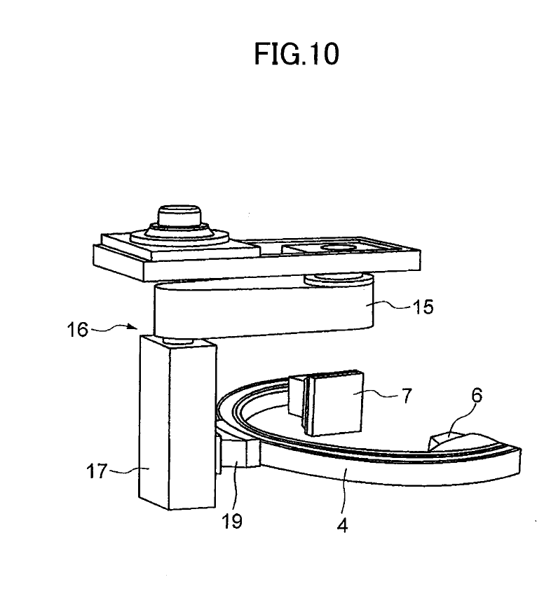

In the third embodiment, description is provided for retreat steps that can be combined with the retreat steps described in the first embodiment or can be preformed independently. FIG. 9 is a perspective view illustrating a first retreat step of retreating the C-arm 4 from the bed 1 in the third embodiment. FIG. 10 is a perspective view illustrating a second retreat step of retreating the C-arm 4 from the bed 1 in the third embodiment.

Note that the following description is provided by taking as an example a case where the X-ray imaging apparatus 2 is in a state after the second or later retreat step in the first embodiment illustrated in FIG. 4. In FIG. 9 and FIG. 10, the second rotation axis 14 is rotated in the arrow C direction and the axial center of the first rotation axis 8 and the axial center of the third rotation axis 16 are located at substantially the same positions.

Here, the third rotation axis 16 has a telescopic mechanism. Thus, the rotation axis housing portion 17 joined to the third rotation axis 16, the not-illustrated horizontal rotation axis 18, the holder portion 19 and the C-arm 4 joined to the holder portion 19 can be moved in any of up-down directions (directions indicted by an arrow I) by extending or retracting the telescopic mechanism. When the third rotation axis 16 is retracted with the telescopic mechanism, the C-arm 4 can be retreated upward from the bed 1.

Specific retreat steps are as follows. As illustrated in FIG. 9, the C-arm 4 is firstly rotated about the axial center of the not-illustrated horizontal rotation axis 18 in an arrow J direction. The C-arm 4 is rotated so that the X-ray generator 6 and the X-ray detector 7 held at both ends of the C-arm 4 can be positioned at almost the same heights, for example.

The reason why the C-arm 4 is firstly rotated as described above is that if the X-ray generator 6 and the X-ray detector 7 are opposed to each other in the up-down direction as illustrated in FIG. 1, for example, the retraction of the third rotation axis 16 may bring the C-arm 4 into contact with the horizontal support arm 15. In order to avoid contact with the horizontal support arm 15, the C-arm 4 is rotated to the aforementioned position.

After that, the third rotation axis 16 is retracted. Through this step, the foregoing rotation axis housing portion 17 and the like joined to the lower end side of the third rotation axis 16 are lifted up to a position close to the horizontal support arm 15. This state is illustrated in the perspective view of FIG. 10.

As illustrated in FIG. 10, the C-arm 4 is moved upward from the bed 1 by driving the C-arm driving mechanism 5. Moreover, the C-arm 4 is rotated in advance to the orientation illustrated in FIG. 10, and thereby is prevented from coming into contact with the horizontal support arm 15, for example.

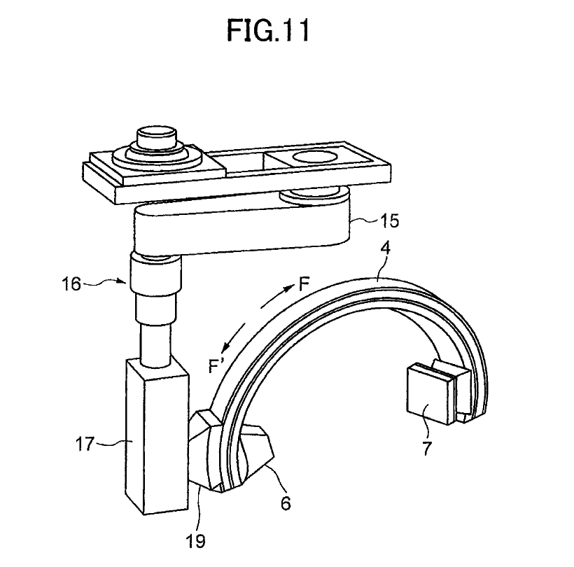

Note that, as for the movement direction of the C-arm 4, the C-arm 4 maybe moved in a direction illustrated in FIG. 11 instead of the direction illustrated in FIG. 10. FIG. 11 is a perspective view illustrating another retreat example where the C-arm 4 is retreated from the bed 1 in the third embodiment.

In the foregoing description, the C-arm 4 is rotated along with the rotation of the not-illustrated horizontal rotation axis 18, and thereby is moved to the orientation illustrated in FIG. 10. In contrast, here, the C-arm 4 is slid in an arc direction, for example, in the F direction. In this way, the C-arm 4 avoids contact with the horizontal support arm 15 and the like, leaves a free space above the floor, and prevents contact with a closely located wall. To be more precise, the C-arm 4 is slid in the arc direction, i.e., in the F direction or the F′ direction, the X-ray generator 6 or the X-ray detector 7 is moved to a position close to the holder portion 19.

Judging from the shape of the C-arm 4, a distance from the isocenter IS to the holder portion 19 under the condition where the imaging axis SA is parallel with the vertical direction is shorter than a distance recognized by connecting both ends of the C-arm 4 on which the X-ray generator 6 and the X-ray detector 7 are held. For this reason, the C-arm 4 is moved to an orientation illustrated in FIG. 11, for example, so that the C-arm 4 avoids contact with the horizontal support arm 15, leaves a free space having a height from the floor to the holder portion 19, and prevents contact with a closely located wall.

Moreover, when the C-arm 4 is positioned in the orientation illustrated in FIG. 10, the arc portion of the C-arm 4 protrudes largely in a plan view of the X-ray imaging apparatus 2. Specifically, as described in the first embodiment, when the second rotation axis 14 and the third rotation axis 16 are rotated about their respective axial centers, the portions joined to these axes 14 and 16 are stored without protruding from the ceiling support arm 10 in the plan view. This state is illustrated in FIG. 4, for example. In this drawing, the axial centers of the first rotation axis 8, the second rotation axis 14 and the third rotation axis 16 are located on a single straight line, and thereby the C-arm 4 and the horizontal support arm 15 are also stored within the length defined by the short side of the ceiling support arm 10. The orientation of the C-arm 4 in this state is set such that the imaging axis SA is parallel with the vertical direction as illustrated in FIG. 1, for example.

On the other hand, when the C-arm 4 is rotated to the orientation illustrated in FIG. 10 as described above in the third embodiment, the C-arm 4 protrudes from the ceiling support arm 10 in the plan view because the length connecting both ends of the C-arm 4 is longer than the length defined by the short side of the ceiling support arm 10. The X-ray imaging apparatus 2 in this state cannot be stored flat against the wall, for example.

To avoid this, the C-arm 4 is moved to the orientation illustrated in FIG. 11 to thereby prevent both ends of the C-arm 4 from protruding from the ceiling support arm 10. As a result, the X-ray imaging apparatus 2 can be retreated to a position much closer to the wall.

As described above, according to the X-ray imaging apparatus of the present embodiment, the C-arm can be retreated from the bed by a sufficient distance by rotating the portions joined to the rotation axes about the respective axial centers. Thus, the C-arm can be prevented from disturbing a surgery.

Moreover, the X-ray imaging apparatus can be made more compact and moreover be stored closer to the wall by rotating or moving the C-arm in an adequate direction, and by moving the C-arm close to the horizontal support arm with the third rotation axis retracted. In this case, the X-ray imaging apparatus can be at a much larger distance from the bed, and thereby can be prevented from disturbing a surgery.

Furthermore, in all the aforementioned embodiments of the present invention, no rails are installed on a ceiling. This makes it possible to offer a sufficient degree of freedom in installation of surgical equipment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray imaging apparatus comprising:
a C-arm formed in a C-shaped arc form, and being capable of sliding in an arc direction;
an X-ray generator held on one end side of the C-arm;
an X-ray detector held on the other end side of the C-arm while being opposed to the X-ray generator; and
a first rotation axis which is fixed at a fixation portion to a ceiling portion of a room where the C-arm is installed, and which enables the C-arm to be rotated about an axial center of the first rotation axis, the axial center being a normal line extending in a vertical direction from the center of the fixation portion.

2. The X-ray imaging apparatus according to claim 1, comprising:
a plurality of rotation axes in the whole X-ray imaging apparatus, the plurality of rotation axes including the first rotation axis, and another or other rotation axes each being rotatable about an axial center being parallel with the axis center of the first rotation axis; and
a horizontal rotation axis configured to rotate the C-arm about a horizontal axial center being orthogonal to the axial centers.

3. The X-ray imaging apparatus according to claim 2, wherein
at least one of the rotation axes is capable of extending and retracting in the vertical direction.

4. An X-ray imaging apparatus comprising:
a first rotation axis fixed at a fixation portion to a ceiling portion and having as an axial center a normal line extending in a vertical direction from the center of the fixation portion;
a holding body joined to the first rotation axis in a manner rotatable about the axial center of the first rotation axis;
a long ceiling support arm joined to the holding body in a manner rotatable about the axial center of the first rotation axis, and extending in a direction horizontal to the ceiling portion;
a sliding body joined to the ceiling support arm and being capable of sliding in a longitudinal direction of the ceiling support arm;
a second rotation axis having a joint portion on an upper end side thereof joined to the sliding body, and having as an axial center a normal line extending in the vertical direction from the center of the joint portion of the second rotation axis;
a long horizontal support arm including one end side joined to a lower end side of the second rotation axis, extending in a horizontal direction and being rotatable about the axial center of the second rotation axis;
a third rotation axis having a joint portion of an upper end thereof joined to the other end side of the horizontal support arm in a longitudinal direction, and having as an axial center a normal line extending in the vertical direction from the center of the joint portion of the third rotation axis;
a rotation axis housing portion joined to a lower end side of the third rotation axis;
a horizontal rotation axis housed in the rotation axis housing portion and having a horizontal axial center being orthogonal to the axial centers;
a holder portion held to be rotatable about the axial center of the horizontal rotation axis;
a C-arm formed in a C-shaped arc form and held by the holder portion in a manner capable of sliding in an arc direction;
an X-ray generator held on one end side of the C-arm; and
an X-ray detector held on the other end side of the C-arm while being opposed to the X-ray generator.

5. The X-ray imaging apparatus according to claim 4, wherein
a length of a long side of the ceiling support arm is longer than a length of a side, parallel with the long side, of the holding body joined to the ceiling support arm.

6. The X-ray imaging apparatus according to claim 4, wherein
the ceiling support arm is capable of sliding in its own longitudinal direction being orthogonal to the axial center of the first rotation axis.

7. The X-ray imaging apparatus according to claim 4, wherein
the third rotation axis includes a telescopic mechanism, and is configured to be capable of extending and retracting in the vertical direction.

8. The X-ray imaging apparatus according to claim 4, wherein
the C-arm provided with the X-ray generator and the X-ray detector at both the ends thereof is rotatable about the horizontal axial center of the horizontal rotation axis.

9. The X-ray imaging apparatus according to claim 4, wherein
a length between the axial center of the third rotation axis and an imaging axis connecting the X-ray generator and the X-ray detector provided to the C-arm is set to be equal to a length between the axial center of the third rotation axis and the axial center of the second rotation axis.
